(19) United States
(12) Patent Application Publication
(10) Pub. No.: US 2009/0141387 A1
(43) Pub. Date: Jun. 4, 2009

(54) NANOPROBE-BASED HEATING APPARATUS AND HEAT-ASSISTED MAGNETIC RECORDING HEAD USING THE SAME

(75) Inventors: Mun Cheol PAEK, Daejeon (KR); Kwang Yong Kang, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/200,359

(22) Filed: Aug. 28, 2008

(30) Foreign Application Priority Data
Nov. 29, 2007 (KR) 10-2007-0122991
Feb. 25, 2008 (KR) 10-2008-0016793

(51) Int. Cl. G11B 5/02

(52) U.S. Cl. 360/59; G9B/5.026; 977/947

(57) ABSTRACT

A nanoprobe-based heating apparatus includes a nanoprobe, a heating unit, a gap control unit, and a support unit. The nanoprobe has a tip forming at an end of the nanoprobe, and the tip applies heat to a magnetic recording bit of a recording medium. The heating unit heats the nanoprobe. The gap control unit controls a gap between the nanoprobe and the recording medium. The support unit supports the nanoprobe, the heating unit, and the gap control unit. The nanoprobe-based heating apparatus is installed at a magnetic recording head of a magnetic hard disk drive to be able to heat an ultra-fine region of a recording medium very rapidly by applying heat together with a magnetic field.

### CROSS-REFERENCE TO RELATED APPLICATIONS

This application claims the priorities of Korean Patent Application No. 10-2007-0122991 filed on Nov. 29, 2007, in the Korean Intellectual Property Office and Korean Patent Application No. 10-2008-0016793 filed on Feb. 25, 2008, in the Korean Intellectual Property Office, the disclosure of which is incorporated herein by reference.

### BACKGROUND OF THE INVENTION

1. Field of the Invention

The present invention relates to a nanoprobe-based heating apparatus and a heat-assisted magnetic recording head using the same, and more particularly, to a heating apparatus with a sharp nanoprobe, which is installed at a magnetic recording head of a magnetic hard disk drive to be able to heat an ultra-fine region of a recording medium very rapidly by applying heat together with a magnetic field.

This work was supported by the IT R&D program of MIC/IITA [2006-S-005-02, Development of THz-wave oscillation/modulation/detection module and signal sources technology]

2. Description of the Related Art

In the magnetic recording technologies, the recording density gradually increases and thus the size of unit recording bit of a recording medium recording unit information tends to be smaller. For example, when the recording density is 10 Gbit/in², the unit recording bit has a size of about 200×300 nm²; when the recording density is 100 Gbit/in², the unit recording bit has a size of about 75×100 nm²; and when the recording density is 1 Tbit/in², the unit recording bit has an ultra-fine size of about 20×30 nm².

If the physical size of the unit recording bit decreases, the number and volume of magnetic particles existing in the unit recording bit decrease, causing a thermal fluctuation. Consequently, the magnetic recording becomes impossible.

That is, in order to function as the magnetic recording apparatus, magnetic particles must maintain at least 10 years magnetization caused by a magnetic induction. However, if the size and volume of the magnetic particles decrease due to the increase of the recording density, the duration is exponentially decreased by the thermal fluctuation. Specifically, when the volume of the unit particle is decreased by ½, the duration around a threshold value is significantly decreased below several seconds in 10 years.

Such a phenomenon is called a superparamagnetism phenomenon. In theory, a recording density limit at which the recording is impossible due to the superparamagnetism phenomenon is about 200-300 Gbit/in². Therefore, such a superparamagnetism phenomenon must be overcome in order to implement the recording density more than the recording density limit of 200-300 Gbit/in².

One of methods for overcoming the superparamagnetism phenomenon is to use magnetic recording particles having a large magnetic anisotropic coefficient. Thus, the magnetization can be retained with a small number of magnetic particles, without thermal fluctuation, thereby making a high-density magnetic recording possible.

However, in this case, since a magnetic coercivity for magnetizing a magnetic material increases, a very strong magnetic field must be used for a recording/erasing operation, which increases the total size and weight of a recording head. In actuality, a recording head larger than a disk drive is necessary for implementing a recording density of Tbit/in² level, which is impracticable.

What is thus required is a technology that can perform a recording operation by means of a weak magnetic field and maintain a magnetized state for a long period, while using a material with a large magnetic anisotropic coefficient. Such a technology makes it possible to implement a recording operation with a super high density of above Tbit/in², overcoming the limit of a superparamagnetism phenomenon.

Recently, extensive research is being conducted to develop a heat-assisted magnetic recording (HAMR) technology that is evaluates as the most competent technology for solving the above limitations.

The HAMR technology applies heat to a recording bit portion together with a magnetic field to reduce a magnetic coercivity, i.e., a magnetic field necessary for a recording operation, thereby making it possible to perform a recording operation by means of a weak magnetic field. To this end, a technology is required that can heat/cool an ultra-fine region to about hundreds of ° C. very rapidly.

A related art method capable of rapidly heating a region of several tens of nm² by means of laser beams is illustrated in FIG. 1, which has been researched extensively.

FIG. 1 is a perspective view of a related art heat-assisted magnetic recording head 1 using laser beams.

Referring to FIG. 1, the heat-assisted magnetic recording head 1 includes a recording head 3 for converting information into a magnetic signal and applying the magnetic signal to a recording medium 2; a reproducing head 4 for detecting recorded bits from the recording medium 2; and a light source 5 for heat assistance.

When the recording medium 2 moves in ‘A’ direction, a light focus 6 is formed at the recording medium 2 by a laser beam radiated from the light source 5 such as a laser diode. After the recording medium 2 is heated by the laser beam, it is magnetized by a leakage magnetic flux generated from the recording head 2, under the condition of a low magnetic coercivity.

The light source formed by the laser beam must be very small in order to perform a high-density recording operation by means of the heat-assisted magnetic recording head 1.

However, a laser beam can be applied to rapid heating and rapid cooling, but cannot be applied to an ultra-fine region smaller than ½ of a wavelength due an optical diffraction limitation. Thus, it is nearly impossible to form a focus with a diameter of below 100 nm, even using a blue ultraviolet laser beam with a wavelength of 200 to 400 nm.

Therefore, a near field is used to solve the above limitation. However, when a near filed is used, an optical efficiency is too low to about 10⁻⁴ to 10⁻⁶ and an expensive and complex optical system must be installed for rapid heating and rapid cooling.

### SUMMARY OF THE INVENTION

What is thus proposed is a heat-assisted magnetic recording (HAMR) technology for overcoming a superparamagnetism phenomenon that is the recording limit of a magnetic disk.

The HAMR technology applies heat together with a magnetic field when performing a data recording operation. In general, near-field laser beams are used to heat/cool an ultra-fine region within the shortest time.

However, the use of laser beams makes it very difficult to achieve an ultra-fine focus due to a diffraction limit, thus failing to obtain the practical results for a high-density recording operation.

Thus, an aspect of the present invention provides a heating method using a nanoprobe instead of near-field laser beams.

An aspect of the present invention also provides a scanning probe memory (SPM) that can apply heat to a recording bit of a recording medium by means of a sharp nanoprobe by using a heating method that is applicable to a heat-assisted magnetic recording technology for implementing a high recording density.

According to an aspect of the present invention, there is provided a nanoprobe-based heating apparatus comprising: a nanoprobe having an end formed a tip for applying heat to a magnetic recording bit of a recording medium; a heating unit heating the nanoprobe; a gap control unit controlling a gap between the nanoprobe and the recording medium; and a support unit supporting the nanoprobe, the heating unit, and the gap control unit.

Preferably, the tip is formed sharply, and is located adjacent to or on the top of the magnetic recording bit in a non-contact state with respect to the recording medium to apply heat to the magnetic recording bit.

Preferably, the tip is located adjacent to or on the top of the recording medium to apply heat to the magnetic recording bit.

Preferably, the heating unit includes an electrical resistor heating the nanoprobe.

Preferably, the gap control unit is a piezoelectric device capable of moving finely according to an electrical signal to control the gap.

According to another aspect of the present invention, there is provided a heat-assisted magnetic recording head comprising; a magnetic recording head applying a magnetic field for a magnetic recording on a magnetic recording bit of a recording medium to magnetize the magnetic recording bit; and a nanoprobe-based heating apparatus installed adjacent to the magnetic recording head to apply heat to the magnetized magnetic recording bit of the recording medium.

Preferably, the nanoprobe-based heating apparatus includes: a nanoprobe having an end formed a tip for applying heat to a magnetic recording bit of a recording medium; a heating unit heating the nanoprobe; a gap control unit controlling a gap between the nanoprobe and the recording medium; and a support unit supporting the nanoprobe, the heating unit, and the gap control unit.

Preferably, the heating unit includes an electrical resistor heating the nanoprobe.

Preferably, the gap control unit is a piezoelectric device capable of moving finely according to an electrical signal to control the gap.

Preferably, the tip is formed sharply, and applies heat in a non-contact state with respect to the recording medium.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a related art heat-assisted magnetic recording head using laser beams;

FIG. 2 is a perspective view of a heat-assisted magnetic recording head having a nanoprobe-based heating apparatus according to an embodiment of the present invention;

FIG. 3 is a conceptual view illustrating the point of a magnetic recording bit of a recording medium, to which heat is applied using the nanoprobe-based heating apparatus according to an embodiment of the present invention; and

FIG. 4 is a conceptual view illustrating the principle of the recording medium being heated by radiating heat from the tip of the nanoprobe according to an embodiment of the present invention.

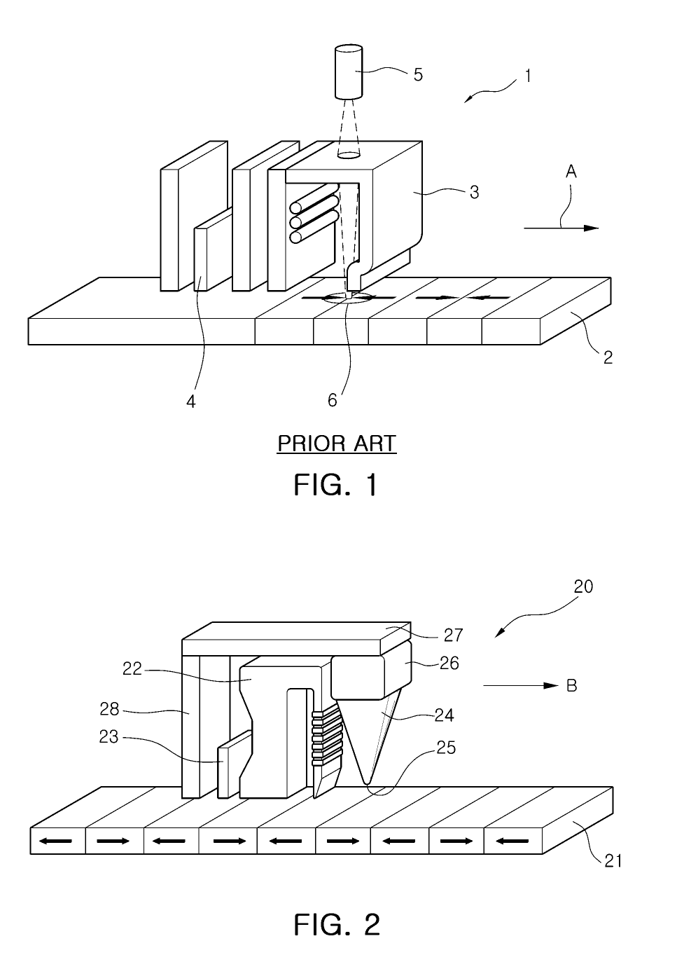

### DETAILED DESCRIPTION OF THE PREFERRED EMBODIMENT

Exemplary embodiments of the present invention will now be described in detail with reference to the accompanying drawings.

In the following description of the embodiments of the present invention, a detailed description of well-known functions and configurations incorporated herein will be omitted when it may obscure the subject matter of the present invention.

In the drawings, the thicknesses and sizes of elements are exaggerated for clarity. Like reference numerals refer to like elements throughout.

It will be understood that when an element is referred to as being “connected to” another element, it may be directly connected to the other element or intervening elements may be present.

It will be further understood that the terms “include” and “comprise,” as well as derivatives thereof, when used in this specification, specify the presence of stated elements, but do not preclude the presence or addition of one or more other elements unless otherwise specified.

FIG. 2 is a perspective view of a heat-assisted magnetic recording head having a heating apparatus with a nanoprobe according to an embodiment of the present invention.

Referring to FIG. 2, a heat-assisted magnetic recording head 20 includes a magnetic recording head 22, a reproducing head 23, and a nanoprobe-based heating apparatus in order to write/reproduce information on a recording medium 21. The nanoprobe-based heating apparatus includes a nanoprobe 24, a heating unit 26, a gap control unit 27, and a support unit 28.

The nanoprobe 24 is installed adjacent to the magnetic recording head 22, and has a tip 25 for applying heat to a magnetic recording bit of the recording medium 21. The heating unit 26 heats the nanoprobe 24, and may be attached on the top of the nanoprobe 25.

The gap control unit 27 controls a gap between the nanoprobe 24 and the recording medium 21, and may be attached on the top of the heating unit 26. The support unit 28 supports the nanoprobe 24, the heating unit 26, and the gap control unit 27, and may be attached to one side of the gap control unit 27.

Specifically, a conventional magnetic recording head and a conventional reproducing head are used as the magnetic recording head 22 and the reproducing head 23, and the sizes and shapes of the magnetic recording head 22 and the reproducing head 23 may vary depending on the performance of a magnetic disk drive.

The nanoprobe 24 and the tip 25 are shaped sharply to heat a fine region, and the tip 25 has a curvature radius of about several nm.

When the heat-assisted magnetic recording head 20 moves in ‘B’ direction, the nanoprobe 24 and the tip 25 are attached in front of the magnetic head 22 and are fixed by the support unit 28.

Also, the tip 25 is located adjacent to or on the top of a recording portion of the recording medium 21 in order to be able to apply sufficient heat for a magnetic recording operation.

The heating unit 26 is implemented using a thermal resistance technique in principle, and may be implemented using other advanced techniques. An electrical resistor for generating resistance heat is connected to the heating unit 26. The electrical resistor is associated with the gap control unit 27 so that a current is prevented from flowing through the electrical resistor in a reproducing or parking mode.

That is, the nanoprobe 24 aims at applying heat to a magnetic recording portion more efficiently, and the gap control unit 27 aims at making the tip 25 and the recording medium 21 maintain a constant gap therebetween in a non-contact state.

Also, since the volume and temperature of the heated portion are closely related with a gap distance between the tip 25 and the recording medium 21, the gap control unit 27 automatically detects the gap distance to control the nanoprobe 24 so that the tip 25 and the recording medium 21 maintain a constant gap therebetween. For automatic control of the gap distance, the gap control unit 27 is formed of piezoelectric material.

Also, the gap control unit 27 is configured to be capable of a fine movement by an electrical signal using the piezoelectric material, and a description of its principle and circuit will be omitted for simplicity.

The support unit 28 serves to support the nanoprobe 24, the tip 25, the heating unit 26, and the gap control unit 27, and does not affect the function and movement of the magnetic recording head 22. Thus, the size and position of the support unit 28 are determined depending on the shape of the magnetic recording head 22 attached thereto, in order to implement the optimal performance.

Thus, the present invention uses the above nanoprobe-based heating apparatus for the heat-assisted magnetic recording head 20, thereby overcoming a superparamagnetism phenomenon, which is the recording limit of a magnetic disk, and thus implementing a high-density recording operation.

Also, since the size (curvature radius) of the tip 25 can be formed finely in a level of several nanometers, the nanoprobe 24 can apply a mechanical scratch, an electric field, heat, or a magnetic field to an ultra-fine region with a diameter of several nm in the recording medium 21 such a disk, thereby enabling a high-density recording/reproducing operation.

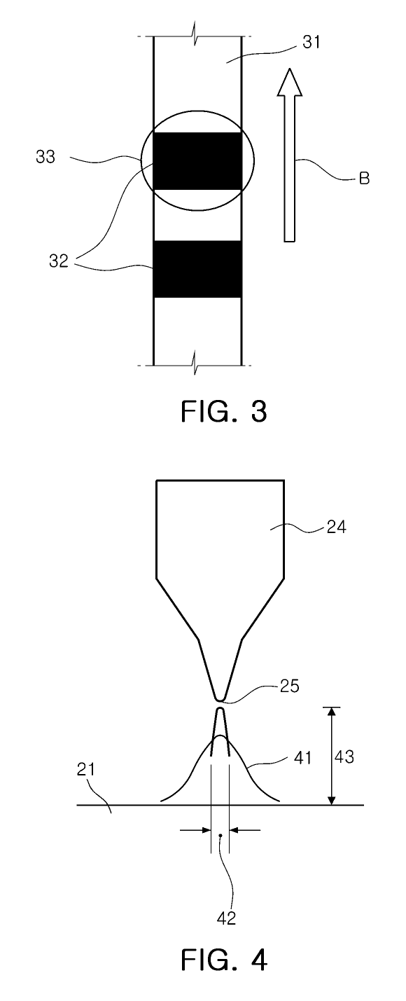

FIG. 3 is a conceptual view illustrating the point of a magnetic recording bit of the recording medium 21, to which heat is applied using the nanoprobe 24 according to an embodiment of the present invention.

Referring to FIG. 3, a magnetic recording bit 32 is magnetized if a magnetic field is applied along a track 31 of the recording medium 21 when the recording medium 21 moves in the direction of an arrow B.

At this point, the present invention uses the tip 25 of the nanoprobe 24 to apply heat to the magnetized magnetic recording bit 32, thereby making it possible to implement a data recording operation by a weak magnetic field.

A portion to which the heat is applied by the nanoprobe 24 is represented by a circled portion 33, which is an ultra-fine region with a diameter of about 30 nm.

FIG. 4 is a conceptual view illustrating the principle of applying heat to the recording medium 21 using the nanoprobe 24 according to an embodiment of the present invention.

Referring to FIG. 4, the distribution of heat radiated from the tip 25 of the nanoprobe 24 is close to the Gaussian distribution. Thus, a temperature region necessary for a magnetic recording operation corresponds to a center portion of the distribution, which depends on the distance between the tip 25 and the recording medium 21.

Therefore, the tip 25 and the recording medium 21 must maintain an about 30 nm gap distance 42 therebetween. To this end, the gap control unit 27 formed of piezoelectric material automatically controls the gap distance between the tip 25 and the recording medium 21 to be about 30 nm.

As described above, the present invention uses a nanoprobe, which is not limited in size, as a heat source for heat-assisted magnetic recording. Therefore, the present invention can be easily applied to a recording head, a reproducing head, for example, commercialized perpendicular magnetic recording (PMR), pattern media, and the next-generation magnetic recording technology.

Also, the present invention can be easily applied to a conventional recording head, thereby overcoming the limitation of the conventional laser near-field. Also, the present invention can apply sufficient heat to an ultra-fine region of a recording medium in a simpler structure and principle, thereby making it possible to achieve a high recording density of a level of T bit/in².

Also, the present invention can automatically control a gap between a recording medium and the nanoprobe-based heating apparatus, which is separately installed at a recording/reproducing head, thereby making it possible for the recording medium to maintain a constant temperature.

While the present invention has been shown and described in connection with the exemplary embodiments, it will be apparent to those skilled in the art that modifications and variations can be made without departing from the spirit and scope of the invention as defined by the appended claims.

What is claimed is:

1. A nanoprobe-based heating apparatus comprising:
a nanoprobe having an end formed a tip for applying heat to a magnetic recording bit of a recording medium;
a heating unit heating the nanoprobe; and
a support unit supporting the nanoprobe and the heating unit.

2. The nanoprobe-based heating apparatus of claim 1, further comprising a gap control unit controlling a gap between the nanoprobe and the recording medium.

3. The nanoprobe-based heating apparatus of claim 1, wherein the tip is formed sharply, and is located adjacent to or on the top of the magnetic recording bit in a non-contact state with respect to the recording medium to apply heat to the magnetic recording bit.

4. The nanoprobe-based heating apparatus of claim 1, wherein the heating unit comprises an electrical resistor heating the nanoprobe.

5. The nanoprobe-based heating apparatus of claim 2, wherein the gap control unit is a piezoelectric device capable of moving finely according to an electrical signal to control the gap.

6. A heat-assisted magnetic recording head comprising:
a magnetic recording head applying a magnetic field for a magnetic recording on a magnetic recording bit of a recording medium to magnetize the magnetic recording bit; and
a nanoprobe-based heating apparatus installed adjacent to the magnetic recording head to apply heat to the magnetized magnetic recording bit of the recording medium.

7. The heat-assisted magnetic recording head of claim 6, wherein the nanoprobe-based heating apparatus comprises:
a nanoprobe having an end formed a tip for applying heat to a magnetic recording bit of a recording medium;
a heating unit heating the nanoprobe;
a gap control unit controlling a gap between the nanoprobe and the recording medium; and
a support unit supporting the nanoprobe, the heating unit, and the gap control unit.

8. The heat-assisted magnetic recording head of claim 7, wherein the heating unit comprises an electrical resistor for heating the nanoprobe.

9. The heat-assisted magnetic recording head of claim 7, wherein the gap control unit is a piezoelectric device capable of moving finely according to an electrical signal to control the gap.

10. The heat-assisted magnetic recording head of claim 7, the tip is formed sharply, and applies heat in a non-contact state with respect to the recording medium.
